(19) United States
(12) Patent Application Publication
(10) Pub. No.: US 2021/0102572 A1
(43) Pub. Date: Apr. 8, 2021

(54) Expansion screw based fastening device

(71) Applicant: Yu-Ju Lin, Kaohsiung (TW)

(72) Inventor: Yu-Ju Lin, Kaohsiung (TW)

(21) Appl. No.: 17/125,970

(22) Filed: Dec. 17, 2020

(51) Int. Cl. F16B 39/02; F16B 35/04; F16B 35/06

(52) U.S. Cl. CPC F16B 39/025; F16B 35/06; F16B 35/041

(57) ABSTRACT

An expansion screw based fastening device includes an expansion screw, an internally threaded member, and a sleeve. The expansion screw includes a head having a plurality of positioning protrusions on a bottom; and a threaded shank. The internally threaded member includes a nut, a constriction member formed with the nut, and an internally threaded hole through both the nut and the constriction member with the threaded shank threadedly passing through. The sleeve includes a fitting member and a moveable hollow member with the fitting member partially disposed therein, the moveable hollow member including a hole for receiving the nut. The fitting member includes positioning members on an outer surface and urging against an inner surface of the hole, and a through hole including a fastening member having threads, and a joining member.

### BACKGROUND OF THE INVENTION

### 1. Field of the Invention

The invention relates to expansion screws and more particularly to an expansion screw based fastening device.

### 2. Description of Related Art

Conventionally, a user drives a bolt of an expansion screw through two workpieces, threadedly puts a nut to the bolt, applies glue into gaps between the bolt and the nut, and finally activates a hydraulic press to apply the hydraulic force to fasten the nut, the bolt and the workpieces together.

However, the conventional expansion screws have following two drawbacks in use: The hydraulic press is bulky and not portable. While horizontal force exerted by the expansion screw is sufficient after the fastening operation, the shear force is not sufficient. Thus, the fastened conventional expansion screw may loosen in response to vertical vibration.

Thus, the need for improvement still exists.

### SUMMARY OF THE INVENTION

It is therefore one object of the invention to provide an expansion screw based fastening device for fastening two workpieces by using a power tool.

It is another object of the invention to provide an expansion screw based fastening device capable of providing sufficient horizontal force and shear force to the fastened workpieces.

To achieve above and other objects of the invention, the invention provides an expansion screw based fastening device comprising an expansion screw, an internally threaded member, and a sleeve wherein the expansion screw includes a head having a plurality of positioning protrusions on a bottom; and a threaded shank; the internally threaded member includes a nut, a constriction member formed with the nut, and an internally threaded hole through both the nut and the constriction member with the threaded shank threadedly passing through; the sleeve includes a fitting member and a moveable hollow member with the fitting member partially disposed therein, the moveable hollow member including a hole for receiving the nut; the fitting member includes a plurality of positioning members on an outer surface and urging against an inner surface of the hole, and a through hole including a fastening member having a plurality of spiral threads, and a joining member configured to join a power tool; and a width of a first end of the fastening member distal the joining member is greater than that of a second end of the fastening member proximate the joining member.

The above and other objects, features and advantages of the invention will become apparent from the following detailed description taken with the accompanying drawings.

### BRIEF DESCRIPTION OF THE DRAWINGS

FIG. 1 is a perspective view of an expansion screw based fastening device according to the invention;

FIG. 2 is a perspective view of the expansion screw;

FIG. 3 is a perspective view of the internally threaded member;

FIG. 4 is a longitudinal sectional view of the internally threaded member;

FIG. 5 is a perspective view of the sleeve;

FIG. 6 is a longitudinal sectional view of the sleeve;

FIG. 7 is a longitudinal sectional view showing the expansion screw driven through two workpieces to be fastened by the internally threaded member;

FIG. 8 is a longitudinal sectional view showing the fastened state of the internally threaded member;

FIG. 9 schematically depicts an adjustment of the sleeve;

FIG. 10 is a view similar to FIG. 8 showing the fastened state of the constriction member; and

FIG. 11 is a view similar to FIG. 10 showing the workpieces fastened by the expansion screw based fastening device.

### DETAILED DESCRIPTION OF THE INVENTION

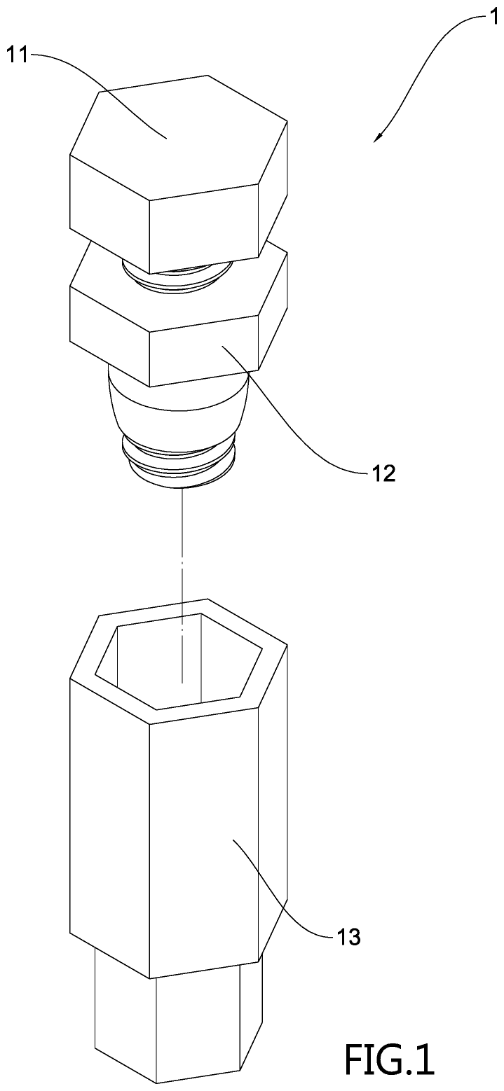

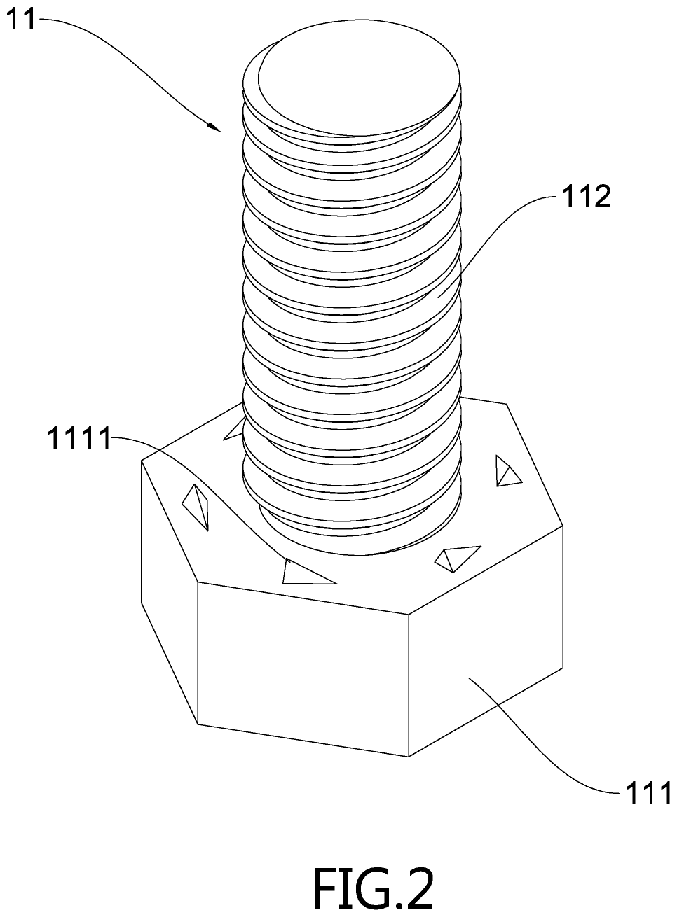

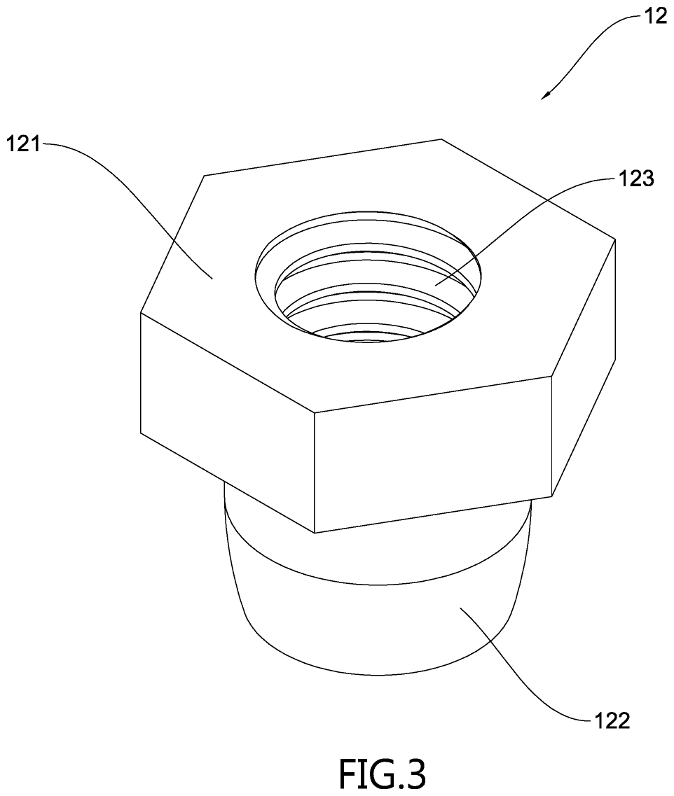

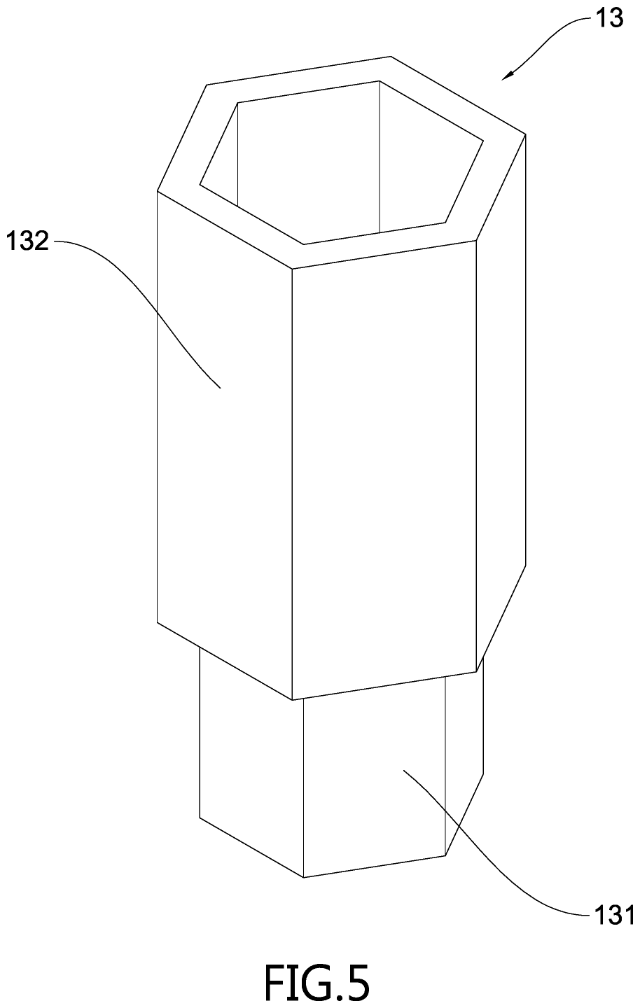

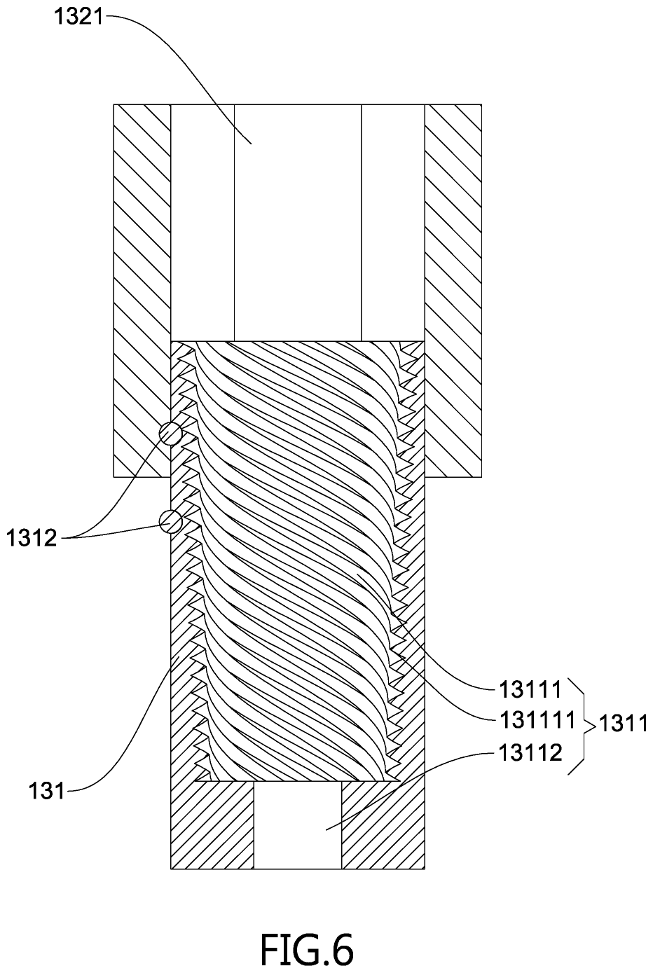

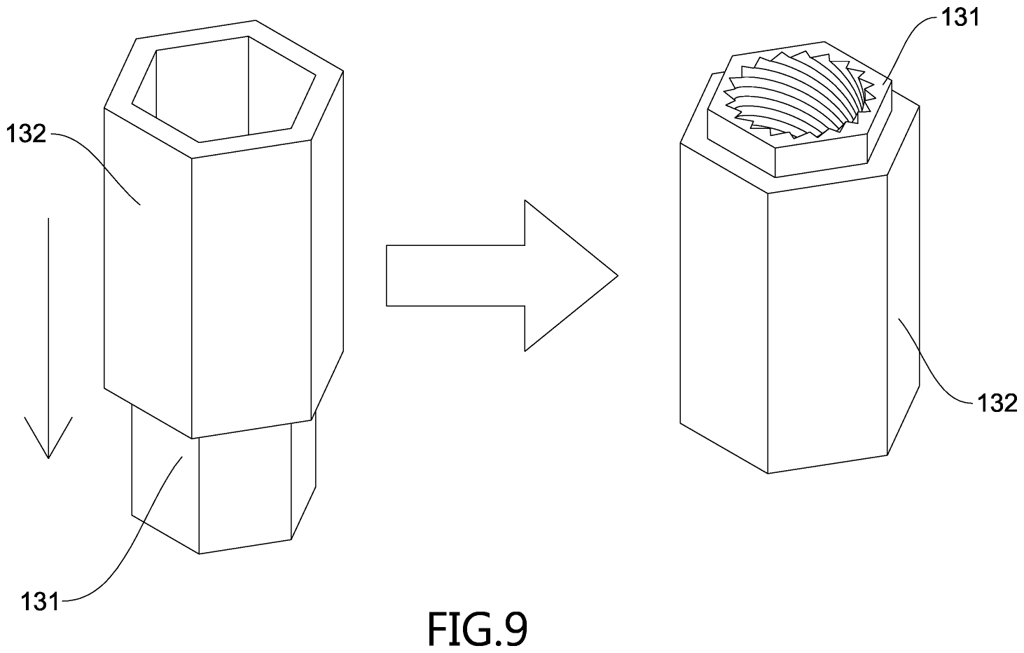

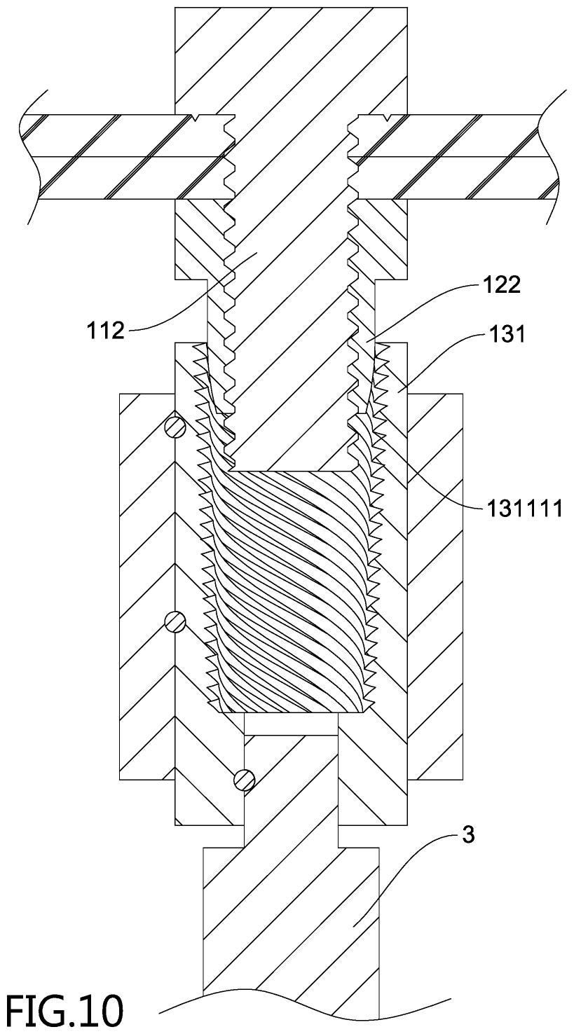

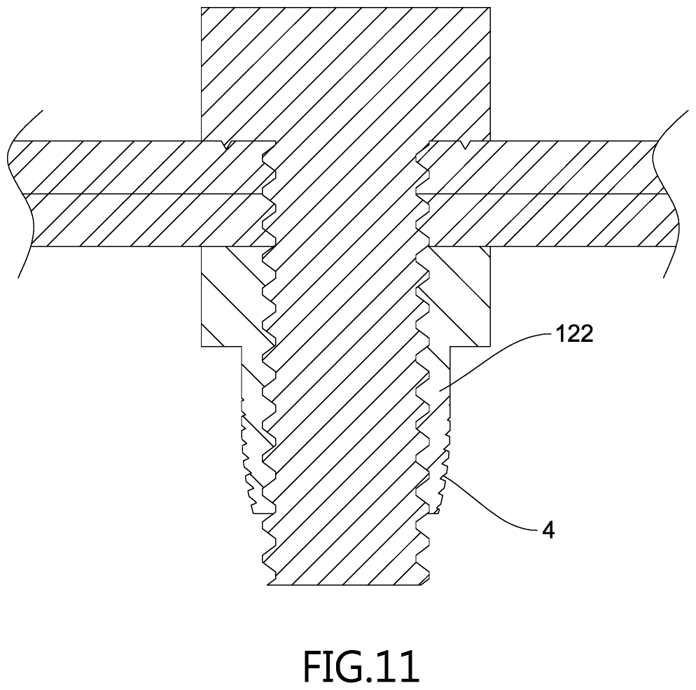

Referring to FIGS. 1 to 11, an expansion screw based fastening device 1 in accordance with the invention comprises an expansion screw 11, an internally threaded member 12 and a sleeve 13 as discussed in detail below.

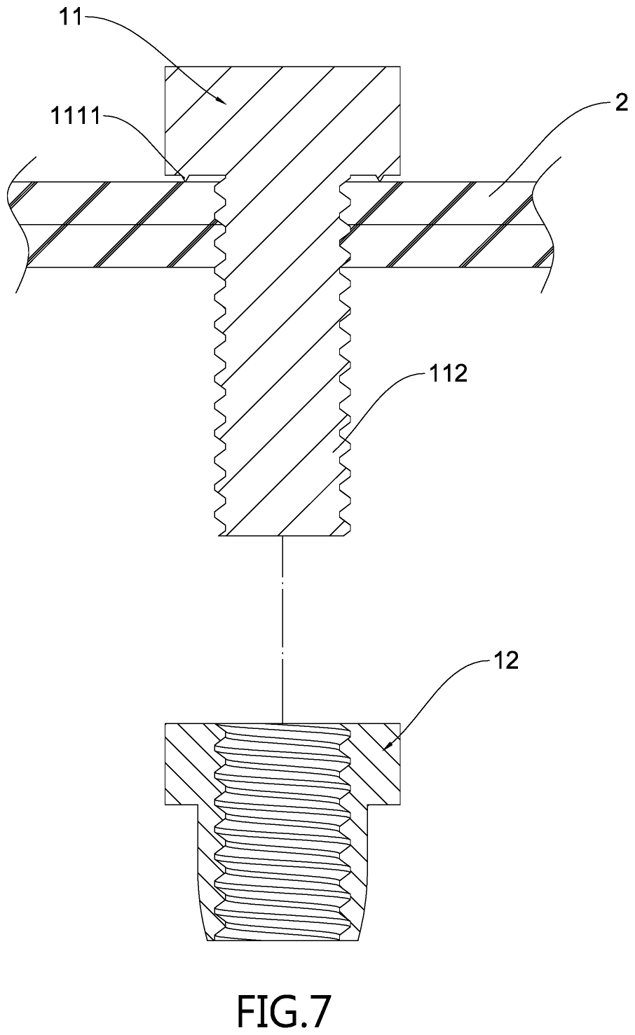

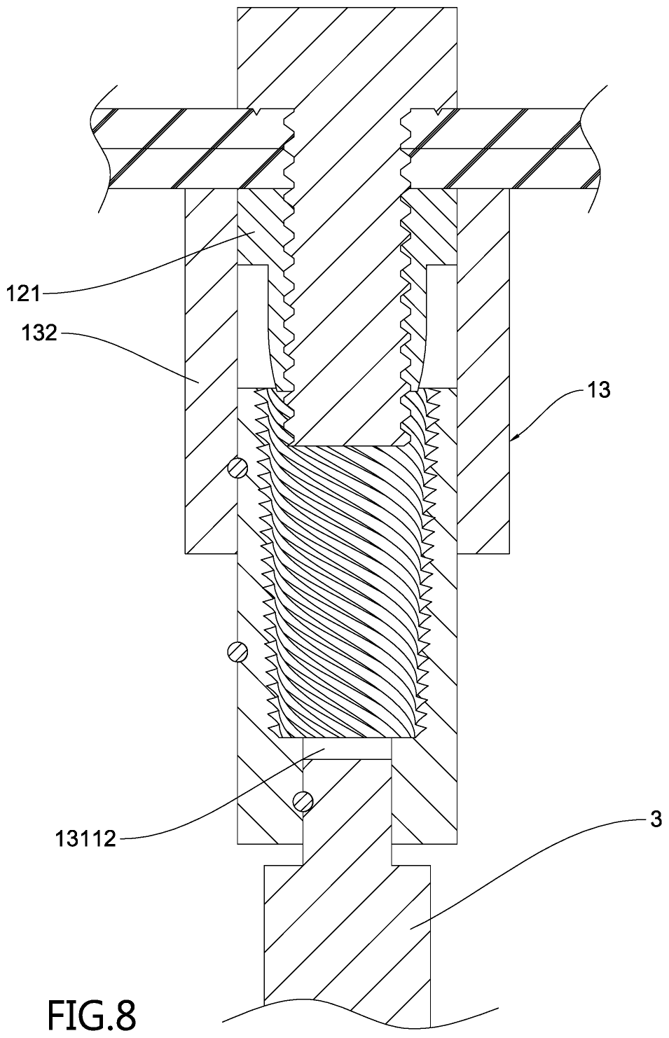

The expansion screw 11 includes a head 111 having a plurality of positioning protrusions 1111 on a bottom adapted to secure to two workpieces 2 (see FIG. 7), the positioning protrusions 1111 being shaped as a triangular prism and formed with the head 111; and a threaded shank 112. The internally threaded member 12 includes a nut 121, a constriction member 122 formed with the nut 121 and having a curved tapered surface 1221, and an internally threaded hole 123 through both the nut 121 and the constriction member 122 with the threaded shank 112 threadedly passing through. The sleeve 13 includes a fitting member 131 and a moveable hollow member 132 with the fitting member 131 partially disposed therein and including a hole 1321 for receiving the nut 121. The fitting member 131 includes a through hole 1311, a plurality of positioning members 1312 on an outer surface and urging against an inner surface of the hole 1321. The through hole 1311 includes a fastening member 13111 having a plurality of spiral threads 131111, and a joining member 13112 adapted to join a power tool 3 (see FIG. 8). Width of an end of the fastening member 13111 distal the joining member 13112 is greater than that of an end of the fastening member 13111 proximate the joining member 13112.

As shown in FIGS. 7 and 8 specifically, in a first stage of a fastening operation a threaded hole is drilled through two workpieces 2. Next, the expansion screw 11 is driven through the threaded hole until the positioning protrusions 1111 contact the workpieces 2 and are stopped by the workpieces 2. Next, the internally threaded member 12 is threadedly put on the threaded shank 112 to urge against the workpieces 2. Next, the sleeve 13 is put on both the nut 121 and a portion of the fitting member 131. Next, the power tool 3 is inserted into the joining member 13112. Next, the power tool 3 is activated to securely urge the internally threaded member 12 against the workpieces 2. The positioning protrusions 1111 gradually insert into the workpieces 2 during the fastening operation. The head 111 urges against the workpieces 2 and the positioning protrusions 1111 are completely inserted into the workpieces 2 at the end of the fastening operation.

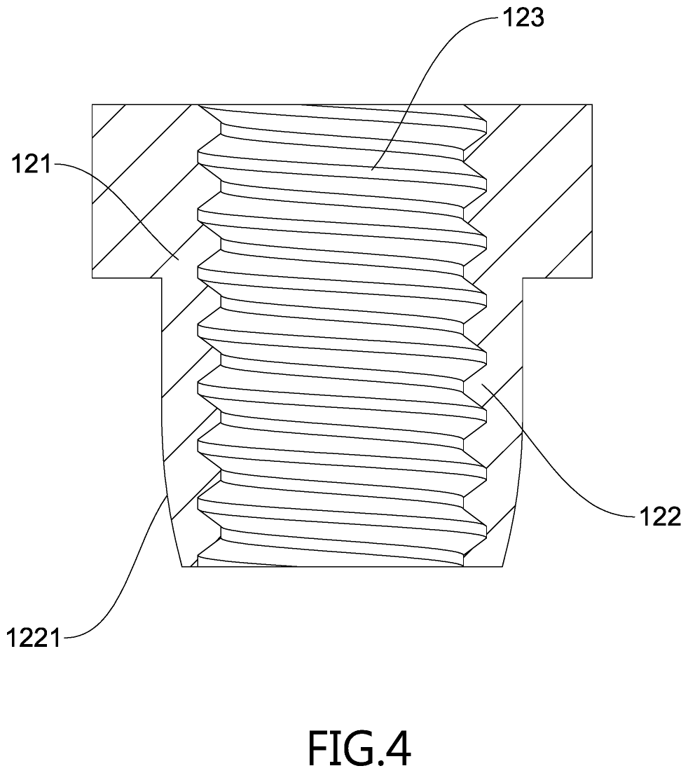

As shown in FIGS. 4, 9, 10 and 11 specifically, in a second stage of the fastening operation the moveable hollow member 132 is pulled downward to expose a front end of the fitting member 131. Next, the fitting member 131 is partially put on the constriction member 122. Next, the power tool 3 is activated to rotate the fitting member 131 to urge the constriction member 122 to eliminate a gap between the internally threaded hole 123 and the threaded shank 112. Also, the constriction member 122 is flexibly deformed to fasten the threaded shank 112. After the fitting member 131 cannot be rotated by the power tool 3, it is confirmed that the fastening operation is finished. Next, the fitting member 131 is counterclockwise rotated to disengage from the constriction member 122. After the fitting member 131 has disengaged from the constriction member 122, a plurality of indentations 4 are formed on the constriction member 122 by the spiral threads 131111.

It is envisaged by the invention that the expansion screw based fastening device 1 has the following advantages: The moveable hollow member 132 and the fitting member 131 are sequentially employed to fasten the internally threaded member 12. A rotation of the power tool 3 finishes the fastening operation. Further, the rotation provides sufficient horizontal and vertical forces to prevent the invention from been loosened.

While the invention has been described in terms of preferred embodiments, those skilled in the art will recognize that the invention can be practiced with modifications within the spirit and scope of the appended claims.

What is claimed is:

1. An expansion screw based fastening device comprising an expansion screw, an internally threaded member, and a sleeve wherein
the expansion screw includes a head having a plurality of positioning protrusions on a bottom; and a threaded shank;
the internally threaded member includes a nut, a constriction member formed with the nut, and an internally threaded hole through both the nut and the constriction member with the threaded shank threadedly passing through;
the sleeve includes a fitting member and a moveable hollow member with the fitting member partially disposed therein, the moveable hollow member including a hole for receiving the nut;
the fitting member includes a plurality of positioning members on an outer surface and urging against an inner surface of the hole, and a through hole including a fastening member having a plurality of spiral threads, and a joining member configured to join a power tool; and
a width of a first end of the fastening member distal the joining member is greater than that of a second end of the fastening member proximate the joining member.

2. The expansion screw based fastening device of claim 1, wherein the constriction member has a curved tapered surface.

3. The expansion screw based fastening device of claim 1, wherein the positioning protrusions are shaped as a triangular prism and formed with the head of the expansion screw.
